(19) United States
(12) Patent Application Publication
(10) Pub. No.: US 2015/0022075 A1
(43) Pub. Date: Jan. 22, 2015

(54) Dielectric Barrier Discharge Apparatus

(71) Applicant: Samuel R. Shortes, Highland Village, TX (US)

(72) Inventor: Samuel R. Shortes, Highland Village, TX (US)

(73) Assignee: ANDERSON REMPLEX, INC., Flower Mound, TX (US)

(21) Appl. No.: 14/332,834

(22) Filed: Jul. 16, 2014

Related U.S. Application Data
(60) Provisional application No. 61/958,155, filed on Jul. 22, 2013.

(51) Int. Cl. H05H 1/24

(52) U.S. Cl. CPC H05H 1/2406; H05H 2001/2412; H05H 2001/2425
USPC 313/268

(57) ABSTRACT

This invention relates to dielectric barrier discharges devices. More particularly, it relates to dielectric barrier discharge apparatus which employ a dielectric barrier disposed within the discharge gap between spaced apart electrodes to generate a plasma when subjected to pulsed high voltages. The dielectric barrier material has a high thermal conductivity and is held in physical contact with a heat sink which aids in dissipation of thermal energy released in formation of the plasma.

This invention relates to plasma discharge apparatus and methods of construction and use. More particularly, it relates to dielectric barrier discharge devices employing a dielectric barrier with relatively high thermal conductivity to aid in distribution and dispersion of excess thermal energy from the barrier material.

Dielectric barrier discharge devices are known to create a plasma discharge in response to application of a pulsed high voltage between opposed electrodes with a dielectric barrier disposed in the gap between the electrodes. The pulsed voltage causes breakdown and ionization of particles to form an ionized or partially ionized gas known as plasma. Although the plasma produced by dielectric barrier discharge devices is referred to as “cold plasma,” considerable thermal energy is generated in the ionization process which is concentrated on the surface of the dielectric barrier.

Common dielectric materials such as quartz and the like exhibit adequate dielectric qualities and characteristics for use as a barrier material. However, such common dielectric materials exhibit extremely poor thermal conductivity characteristics. Accordingly, rapid and continuous generation of thermal energy adjacent the surface of common dielectric materials causes thermal shock and explosive degeneration of structural integrity of the dielectric barrier when continuous or high power voltages are applied in dielectric barrier discharge devices employing common dielectric materials as barriers.

It has been discovered that dielectric materials having a relatively high thermal conductivity, when arranged in a dielectric barrier discharge device in thermal contact with suitable thermal dissipation devices, not only provide the required characteristics for a dielectric barrier, but also provide a thermal conduction path for transferring thermal energy directly and rapidly from the surface of the barrier (which is disposed within the dielectric barrier discharge device) to an external heat sink, thereby avoiding thermal shock and potential disintegration of the barrier material.

Dielectric barrier discharges devices employing the principles of the invention may be used to provide plasma activated fluids, either gaseous, liquid or mixtures thereof, for various applications. Such devices may provide a source of highly reactive gases by directing a fluid such air through the reactor device. Using the principles of the invention, such reactors may be fabricated and operated inexpensively using relative inexpensive and readily available materials which withstand the high voltage loads and thermal stresses encountered in continuous production of plasma discharges. Other features and advantages of the invention will become more readily understood from the following detailed description taken in connection with the appended claims and attached drawing in which:

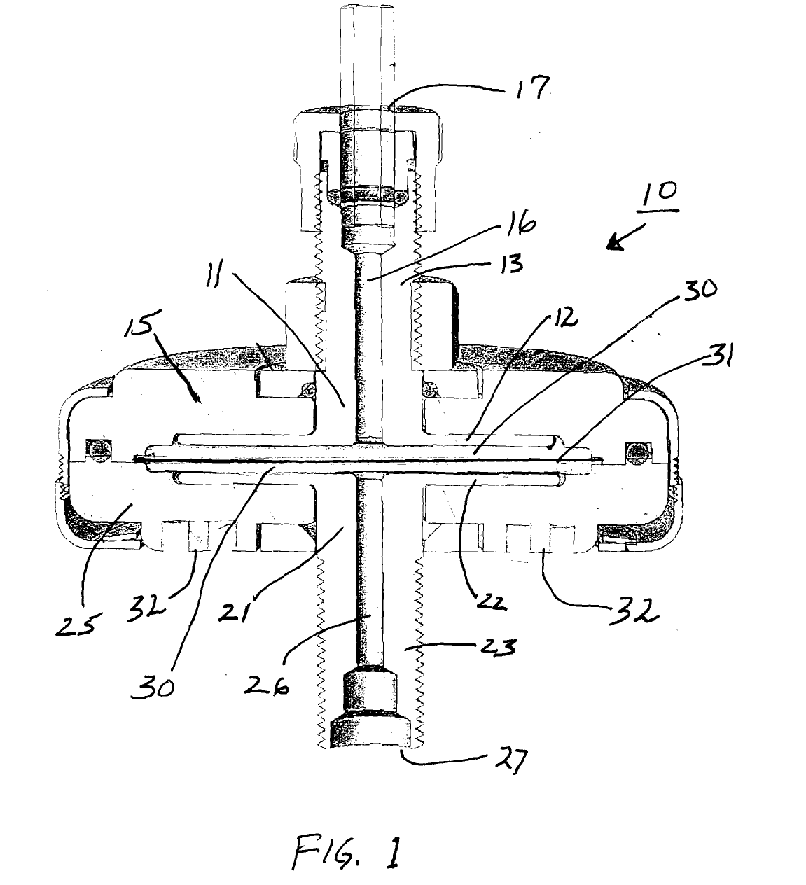

FIG. 1 is a sectional view of a dielectric barrier discharge reactor device employing the principles of the invention to produce a plasma-activated fluid stream.

It will be recognized that the principles of the invention may be utilized and embodied in many and varied forms, and that various materials, component parts and arrangements of components may be employed in utilizing the invention. In order to demonstrate these principles, the invention is described herein by reference to a specific preferred embodiment for use in a specific application. The invention, however, is not limited to the specific forms and/or applications illustrated and described in detail herein.

Dielectric barrier discharge devices may take many forms and be in various configurations. For example, the reactor device may be a simple pair of parallel spaced apart electrodes with a dielectric barrier positioned in the space or gap between the electrodes. Alternatively, the device may be in the form of concentric spaced apart electrodes with the dielectric barrier supported in the concentric space between the electrodes or attached to one of the electrodes. Other configurations will be found suitable for some applications.

The device illustrated in FIG. 1 is a reactor designed to produce a continuous stream of plasma-activated gas. The reactor 10 comprises a first electrode 11 of electrically conductive metal formed in the shape of a threaded stud 13 supporting a first flat plate 17 and a second electrode 21 of electrically conductive metal formed in the shape of a threaded stud 23 supporting a second flat plate 22.

Electrodes 11 and 21 are supported in a housing comprised of a first base 15 and a second base 25 which mate to define an enclosed chamber 30. Electrode 11 is supported in first base 15 and electrode 21 is supported in second base 25. The electrodes are positioned so that the flat plates 12 and 22 are disposed within chamber 30 in parallel and spaced apart relationship and electrically isolated from each other.

An inlet channel 16 provides an conduit for gas to pass from inlet 17 through threaded stud 13 and flat plate 12 into chamber 30. Similarly, an exit channel 26 provides a conduit for fluid to pass from chamber 30 through flat plate 22 and threaded stud 23 to exit 27. A dielectric barrier in the form of a thin plate 31 is positioned within chamber 30 parallel with and between spaced apart plates 12 and 22.

It will be observed that the first base 15 and second base 25 support the flat plates 12 and 22 in parallel spaced apart relationship within an enclosed chamber 30 which has an inlet 17 and an exit 27. The dielectric plate 31 is also supported by base 15 and base 25 within the chamber 30 between the flat plates 12 and 22. When a fluid such as air is passed through the chamber 30 and a pulsed high voltage applied to the electrode plates 12 and 22, a plasma is generated in chamber 30. The plasma-activated gas formed in chamber 30 then exits through exit 27.

In the configuration illustrated, base 15 and base 25 are electrically insulating materials, preferably a dielectric such as aluminum nitride. Thus the conductive plates 12 and 22 are electrically isolated from each other and dielectric plate 31 is held in physical contact with first base 15 and second base 25 and also electrically isolated from the conductive plates 12 and 22.

In order to permit gas to pass through the chamber 30, bypass channels in the form of depressions or the like are formed in the mating edges of first base 15 and second base 25. However, since the dielectric plate 31 is held in physical contact with base plate 15 and base plate 25, the base plates 15 and 25 act as heat sinks to collect and dissipate thermal energy from the dielectric plate 31. Fins 32 may be formed in either or both base plates to aid in dissipation of thermal energy.

In the embodiment illustrated, the thickness of the dielectric plate may be less than 0.5 mm to more than 2.0 mm, depending on the material of the dielectric plate, the gas to be passed through the reactor device, the voltage and pulse frequency to be applied and the gap between the conductive plates. In a typical reactor device in which air is the gas passing through the chamber 30, the space between the electrode plates is approximately 1.0 to 3 0 mm when pulsed voltages in the range of about 10 Kv to about 50 Kv are applied.

While various materials exhibiting dielectric and thermal conductivity characteristics are known and available, the preferred dielectric barrier material for use in this invention is aluminum nitride (AlN). AlN barriers can be formed in various compositions and structural configurations. Powdered sintered AlN and polycrystalline AlN can be machined and/or otherwise formed in thin sheets or other configurations suitable for use as dielectric barriers and exhibit thermal conductivities in the range of about 70 to about 210 watts per meter Kelvin (W/m° K). Although much more expensive, single crystal AlN exhibits a thermal conductivity in the range of about 285 W/m° K and can be formed into configurations suitable for use as dielectric barriers in a variety of dielectric discharge barrier devices.

To best exploit the advantages of using a dielectric material having high thermal conductivity, the dielectric barrier must be in thermal contact with a suitable heat sink or similar means for dissipating thermal energy collected on or near the surface of the dielectric barrier. In the embodiment illustrated in FIG. 1, first base 15 and second base 25 are formed of dielectric barrier material such as aluminum nitride thus act as highly effective heat sinks. Other thermally conductive materials may be used, of course, so long as they are either electrically insulating materials or are electrically isolated from the metal electrodes 11 and 21.

While only exemplary embodiments of the invention have been illustrated and described in detail herein, it will be readily recognized that the principles of the invention may be used in various forms to provide apparatus for forming plasma-activated gas. It is to be understood, therefore, that even though numerous characteristics and advantages of the invention have been set forth in detail herein, the foregoing description, together with details of the structure and function of the various embodiments, is to be considered illustrative only. Various changes and modifications may be made in detail, especially in matters of shape, size and materials as well as arrangement and combination of parts, without departing from the spirit and scope of the invention as defined by the appended claims.

What is claimed:

1. Dielectric barrier discharge apparatus comprising:
a) opposed spaced electrodes defining a discharge gap; and
b) a dielectric material positioned within said discharge gap between said electrodes and in thermal transfer contact with thermal energy dissipating means, wherein said dielectric material has a thermal conductivity of at least about 70 W/m° K.

2. Dielectric barrier discharge apparatus as defined in claim 1 wherein said dielectric material is aluminum nitride.

3. Dielectric barrier discharge apparatus as defined in claim 2 wherein said aluminum nitride is in the form of a plate of polycrystalline aluminum nitride approximately 0.5 mm thick.

4. Dielectric barrier discharge apparatus as defined in claim 1 wherein said thermal energy dissipating means is a dielectric material which has a thermal conductivity of at least 70 W/m° K.

5. Dielectric barrier discharge apparatus as defined in claim 1 wherein said thermal energy dissipating means is aluminum nitride.
